(19) United States
(12) Patent Application Publication
(10) Pub. No.: US 2002/0084287 A1
(43) Pub. Date: Jul. 4, 2002

(54) Pearlescence powder dispensing container useable with a semi-automated automotive paint dispensing system

(75) Inventor: Arie Boers, Plymouth, MN (US)

Correspondence Address: Thomas A. Rendos, Dicke, Billig & Czaja, P.A., Suite 1250, 701 Fourth Avenue South, Minneapolis, MN, 55415, US

(73) Assignee: X-PERT Paint Mixing Systems, Inc.

(21) Appl. No.: 09/998,672

(22) Filed: Nov. 29, 2001

Related U.S. Application Data
(63) Continuation-in-part of application No. 09/854,879, filed on May 14, 2001.
Application No. 09/854,879 is a continuation of application No. 09/504,311, filed on Feb. 15, 2000, now Pat. No. 6,230,938.

(51) Int. Cl. B67D 5/64

(52) U.S. Cl. 222/166; 222/559

(57) ABSTRACT

A dry pourable paint component dispensing container usable with a system for dispensing the dry paint component from the dispensing container into a paint receptacle according to a paint formula to form a paint mixture. The dispensing container includes a main body for containing the dry pourable paint component. The main body has a dispensing opening through which the dry paint component can be dispensed and a movable cover element. The cover element is movable between a closed state, wherein the paint component is prevented from being dispensed, and an opened state, wherein the dispensing opening is uncovered and the paint component can be dispensed from the dispensing container and into the paint receptacle. An operating arrangement on the cover element is releasably engageable by an operating device of the dispensing system that moves the cover element between its closed and opened states. An alignment mechanism on the dispensing container aligns the container with the dispensing system, while a latching arrangement of the container releasably secures the container to the dispensing system. A movable shaker sleeve mechanism within the dispensing container prevents bridging of the particles that define the dry pourable paint component.

### CROSS REFERENCE TO RELATED APPLICATIONS

This patent application is a continuation-in-part of U.S. Pat. application Ser. No. 09/854,879 filed May 14, 2001 which is a continuation of U.S. Pat. No. 6,230,938, issued May 15, 2001 entitled “Seal Structure For A Fluid Pour Spout Of A Paint Container Lid Member”, both of which are assigned to the same assignee as herein, and incorporated herein by reference thereto. In addition, this patent application is related to U.S. Pat. No. 6,053,218, issued Apr. 25, 2000 entitled “Semi-Automated System For Dispensing Automotive Paint”; U.S. Pat. No. 6,095,373, issued Aug. 1, 2000 entitled “Paint Container Lid For A Semi-Automated Automotive Paint Dispensing System”; U.S. Pat. No. 6,146,009, issued Nov. 14, 2000 entitled “Paint Container Lid Member Adaptable For Use With A Plurality Of Paint Mixing Systems”; U.S. Pat. No. 6,206,250, issued Mar. 27, 2001 entitled “Lid Member For A Paint Container Useable With A Semi-Automated Automotive Paint Dispensing System”; U.S. Pat. No. 6,234,218, issued May 22, 2001 entitled “Semi-Automated Automotive Paint Dispensing System”; and U.S. Pat. No. 6,290,110, issued Sep. 18, 2001 entitled “Fluid Seal For A Pour Spout Of A Paint Container Lid Member” all of which are assigned to the same assignee as herein, and incorporated herein by reference thereto.

### TECHNICAL FIELD

This invention relates to mixing paint components, such as colorants, tints and pearls, to create automotive paint formulas. In particular, the present invention is a container for storing and dispensing a pearlescence powder component used in certain automotive paint formulas. The container can be used with a semi-automated system for dispensing paint components according to a desired paint formula, or can be manually operated to dispense the pearlescence powder component.

### BACKGROUND OF THE INVENTION

In the automotive body repair industry, paint vendors provide auto body repair businesses, such as body shops and jobbers, with their paint formulas. Generally, these paint formulas are a composition (i.e., mixture) of paint components, such as colorants, tints, pearls, metallics, binders and/or balancers, that, once mixed, produce the desired color of paint to be applied to a repaired vehicle. The paint formulas of the paint vendors are formulated to match the colors that have been applied to vehicles by new car manufacturers over the years. In addition, these paint formulas include variants, to match the color fading of paint that can occur to a vehicle over years of service. Moreover, the palettes of paint formulas of the paint vendors also have custom colors (i.e., unconventional colors not typically used by vehicle manufacturers) that may be used to produce special finishes for custom or show cars. Hence, paint vendors provide body shops and jobbers with literally thousands of paint formulas for producing the vast spectrum of colors needed in the automotive body repair industry.

In the past, paint vendors would provide the body shops and jobbers with microfiche containing their paint formulas. Today the paint formulas are stored in computer memory. To determine the particular paint formula for a particular vehicle repair/paint job or a custom/show car special finish, a system operator, such as an employee of the body shop or jobber, first obtains the color code of the desired paint finish. In the case of a vehicle repair/paint job, this color code is typically part of the vehicle's identification number. In the case of an unconventional color, to be used to produce a custom paint finish, the code for a particular color is obtained from a catalog. This color code is then entered into the microprocessor of the computer, which accesses the computer memory, and displays, via a monitor, the paint vendor's paint formula which matches the identified color code.

The paint formulas are displayed according to the weight of the different paint components for mixing specific quantities of the paint formula, and the order in which the displayed paint components are to be mixed. Typically, paint formula mixing quantities are listed in quart, half gallon and gallon sizes, while the weight of the particular paint components needed to mix the desired quantity of paint, are listed in grams to a precision of a tenth of a gram. Generally, the paint components comprising tints, colorants, pearls and/or metallics are mixed first, while the paint components comprising binders and/or balancers are added last. Depending on the desired color, the paint formula can require just a few paint components, or over a dozen paint components, that must be mixed with a great degree of precision, to achieve a perfect color match.

Generally, the various liquid paint components (of which there are dozens) are stored in containers kept within a rack. The rack has a mechanism that periodically stirs the liquid paint components within the containers, so that the various liquid paint components are ready to be dispensed as part of the paint formula mixing process. Typically, these containers are the original quart and gallon sized metal containers within which the liquid paint components are shipped to the body shop or jobber. In metric system countries, these containers are the original one liter and four liter sized metal containers within which the liquid paint components are shipped to the body shop or jobber. The original covers of these containers are replaced by specialized paint container lids that include stirring paddles that work with the stirring mechanism of the rack. These specialized paint container lids also have pour spouts that allow the paint components of the containers to be dispensed (i.e., poured out) into the receptacle atop the weigh cell. The pour spout of the specialized paint container lid is covered by a cover element that helps to protect the liquid paint component within the container from contaminants. The cover element for the pour spout is movable between an opened state in which the liquid paint component can be poured from its container through the pour spout by tipping (i.e., tilting) the container, and a closed state. The specialized paint container lid typically includes a vent to allow air to enter the container to displace the liquid paint component dispensed from the pour spout.

Certain paint components to be mixed to form the desired paint formula are not in liquid form. These dry or powdered (i.e., granular) paint components are stored in their original containers and are dispensed therefrom. These dry paint components do not require periodic mixing as do the liquid paint components. One such dry paint component is pearlescence powder. This pearlescence powder paint component is typically found in certain special “pearlescent” paint finishes for custom or show cars. This dry pearlescence powder paint component when included in a paint formulation creates a paint finish having a pearly luster or gloss.

Once the system operator determines that the correct desired paint formula is displayed on the computer monitor, the operator can begin the process of mixing (i.e., creating) the desired color paint formula. First, the operator places a paint receptacle on a weigh cell that is linked to the microprocessor of the computer. Generally, a receptacle larger than the quantity of paint formula to be mixed is used to accommodate any excess paint inadvertently mixed by the operator. With the receptacle on the weigh cell, the weigh cell is zeroed by the operator, to make ready for the process of adding paint components to the receptacle to mix the desired color paint formula.

To reproduce the desired paint formula, the system operator begins by identifying the first listed paint component of the paint formula to be mixed. The operator then pours, by hand, the paint component (either liquid or dry) into the weigh cell supported paint receptacle, until the weight of the paint component dispensed (i.e., poured) into the receptacle matches what is displayed on the computer monitor. The operator continues along on this course (i.e., hand pouring the liquid and dry paint components from their containers), until the correct weight of all paint components, needed to mix the desired color paint formula, have been added to the paint receptacle atop the weigh cell.

Although the above described system for mixing paint components (according to a paint formula), using the original containers of the liquid and dry paint components and the above described specialized container lids used in connection with the liquid paint components, allows a skilled system operator to dispense the needed liquid and/or dry paint components to adequately recreate paint colors needed for repair/custom paint jobs, there are some disadvantages to this system. For example, during the process of dispensing the liquid paint component from the specialized container lid, the liquid paint component often undesirably flows out of the vent in the paint container lid fouling the exterior of the container lid. As a further example, dispensing of the dry paint component from its original container is sometimes made difficult due to the “bridging” affect of the particles that make up the dry component. These particles over time tend to form interconnections with one another and the original container that can cause the dry component to be dispensed in undesired clumps.

Moreover, to mix a desired paint formula requires that the liquid and dry paint components be added to the paint receptacle, atop the weigh cell, with a great degree of accuracy. This accuracy, as stated earlier, is typically to a precision of 0.1 grams. For even a highly skilled operator this great degree of precision is difficult to obtain when hand pouring the liquid and dry paint components needed to mix the desired paint formula. It is especially difficult when many liquid and/or dry paint components must be poured into the paint receptacle in order to duplicate the paint formula.

The most common error on the part of the system operator of the body shop or jobber is over pouring which is due primarily to the manual labor intensive nature of the liquid and dry paint component dispensing process. Over pouring occurs when the weight of the liquid or dry paint component added to the receptacle atop the weigh cell, exceeds the weight of the component shown on the computer display for the desired paint formula. When this happens, the microprocessor of the computer recalculates the weights of the other paint components that need to be added to the receptacle to compensate for the over poured component. This recalculation is done automatically by the microprocessor since the weigh cell is linked to the computer. Based upon this recalculation, the system operator then needs to re-pour the other paint components to offset the over poured component of the paint formula.

While this re-pouring task may not be difficult when the paint formula only has a few paint components, the re-pouring task is particularly time consuming when there is a great number of liquid and/or dry components in the paint formula. Specifically, if an over pouring error is made in the last paint component of a series of ten components of a paint formula, then all of the previous nine components may have to be re-poured to compensate. This re-pouring task may be further complicated if another error is made during the re-pouring of the paint components, as this further error may require that some components be re-poured two or three times until the paint formula is finally accurately reproduced. Hence, over pouring errors can be costly to a body shop or jobber because of the additional man hours needed to mix the paint formula.

Not only are over pouring errors expensive because of the additional man hours needed to reproduce the paint formula, over pouring errors are also costly in the amount of additional paint formula that is mixed because of the errors. A six ounce container of a pearlescence powder in and of itself can cost $100.00. As such, a mixed automotive paint formula employing this dry paint component can easily cost in excess of $100.00 per quart. Therefore, an over pouring error of just one pint may translate into an additional cost of $50.00 that a body shop or jobber may have to absorb, unless this additional paint cost can be justified to an automobile collision insurance carrier. Moreover, this additional paint, if not used in the repair/custom paint job, becomes a hazardous waste that must be disposed of properly, thereby adding still more costs that are attributable to paint component over pouring errors.

Therefore, there is a need for improved systems for mixing liquid and dry paint components according to a paint formula. In particular, there is a need for a dry paint component dispensing container, that is compatible with a system for dispensing paint components according to a paint formula that substantially eliminates system operator errors, specifically over pouring errors, that can be costly to a body shop or jobber. The dry paint component dispensing container together with the paint component dispensing system should be easy to use, so as not to require a highly skilled operator, and should make better use of an operator's time to allow an operator to mix a greater number of paint formulas during a work day. Moreover, the dry paint component dispensing container should prevent “bridging” of the particles that make up the dry paint component to as to insure that the dry paint component is dispensed in a smooth, controlled manner (i.e., not in clumps) from the dry component dispensing container. In addition, the dry paint component dispensing container and the paint component dispensing system should comply with all regulations and laws governing the handling and mixing of liquid and dry paint components for the duplication of automotive paint formulas.

### SUMMARY OF THE INVENTION

The present invention is a container for dispensing a dry pourable component, such as a pearlescence powder paint component. The container is usable with a system for dispensing the dry pourable component from the container into a paint receptacle according to a formula to form a mixture of liquid and dry pourable components. The container includes a main body for containing the dry pourable component. The main body defines a dispensing opening through which the dry pourable component can be dispensed from the main body of the container. A cover element is movably mounted to the main body such that the cover element is movable between a closed state, wherein the cover element covers the dispensing opening and the dry pourable component is prevented from being dispensed from the main body of the container, and an opened state, wherein the dispensing opening is uncovered and the dry pourable component can be dispensed from main body of the container through the dispensing opening and into the receptacle.

An operating arrangement on the cover element is releasably engageable by an operating device of the dispensing system that moves the cover element between its closed and opened states according to the formula to form the mixture of pourable components. An alignment mechanism, defined by an alignment slot adjacent the dispensing opening of the main body, is releasably engageable by a engaging mechanism of the paint component dispensing system for aligning the container on the dispensing system so that the operating device is in engagement with the operating arrangement on the cover element. A latching arrangement, defined by a pair of spaced latch lugs on main body of the container, are releasably engageable by a latching mechanism of the paint component dispensing system for securing the container on the dispensing system so that the operating device can move the cover element between its closed and opened states. A linearly movable sleeve member within the main body and linked to the cover element so as to move linearly when the cover element is moved between closed and opened states acts as a shaker mechanism to prevent bridging of the particles that define the dry pourable component.

The dry pourable component dispensing container is compatible with a semi-automated system for dispensing paint components that virtually eliminates system operator errors, in particular over pouring errors, that can be costly to a body shop or jobber. The dry pourable component dispensing container and the semi-automated dispensing system are easy to use, and do not require a highly skilled operator, since operator interface with the dispensing containers and the dispensing system is substantially limited to identifying the desired paint formula, and loading and unloading the proper containers of the paint components to and from the dispensing apparatus using the aligning mechanism and latching arrangement of the lid member.

The operating arrangement of the cover element of the dispensing container is releasably engageable with the operating device of the dispensing system which acts to move the cover element between its closed and opened states. This lid member/dispensing system interface automatically dispenses (i.e., pours) the dry paint components from their containers, thereby ensuring a highly accurate, precision paint component pour. This highly accurate liquid paint component pour substantially limits the additional cost of the added paint components attributable to over pouring errors. Moreover, the movable shaker mechanism prevents undesired bridging of the particles that define the dry pourable component so that the dry pourable component is dispensed from the dispensing opening in a smooth consistent manner. In addition, the dispensing container of the present invention together with the paint dispensing system makes efficient use of the operator's time, since the operator is free to perform other duties instead of manually pouring the proper amounts of the paint components from their containers. This efficiency gain allows the operator to mix a greater number of paint formulas during a work day. Lastly, the dry paint component dispensing container, of the present invention, together with the semi-automated dispensing system complies with all regulations and laws (such as being explosion protected) governing the safe handling and mixing of paint components for the duplication of automotive paint formulas.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principals of the invention. Other embodiments of the present invention and many of the intended advantages of the present invention will be readily appreciated as the same become better understood by reference to the following detailed description when considered in connection with the accompanying drawings, in which like reference numerals designate like parts throughout the figures thereof, and wherein:

FIG. 1 is a perspective view illustrating a dry pourable component dispensing container in accordance with the present invention and a dispensing and control apparatus of a semi-automated system useable with dispensing container of the present invention to dispense a dry paint component, as well as liquid paint components from their original containers.

FIG. 2 is an enlarged perspective view better illustrating the dispensing apparatus of the dispensing system of FIG. 1.

FIG. 3 is a side elevational view of the dry pourable paint component dispensing container in accordance with the present invention with a cap member shown detached and the container being filled with the dry pourable paint component.

FIG. 4a is a side elevational view similar to FIG. 3 of the dispensing container with the cap member shown attached and a dispensing opening cover element in a closed state.

FIG. 4b is side elevational view similar to FIG. 4b with the dispensing opening cover element in an opened dispensing state.

FIG. 5 is a side elevational view of the dispensing container shown in a storage position (i.e., a non-use state) atop a support surface.

FIG. 6a is an end elevational view corresponding to FIG. 4a of the dispensing container in accordance with the present invention.

FIG. 6b is an end elevational view corresponding to FIG. 4b of the dispensing container in accordance with the present invention.

FIG. 7 is a bottom elevational view of the dispensing container in accordance with the present invention with the dispensing opening cover element in the closed state.

FIG. 8a is a partial sectional view taken along line 8a-8a in FIG. 6a illustrating a shaker sleeve member of the dispensing container in a lower position in accordance with the present invention.

FIG. 8b is a partial sectional view similar to FIG. 8a taken along line 8b-8b in FIG. 6b illustrating the shaker sleeve member of the dispensing container in an upper position in accordance with the present invention.

FIG. 9 is an enlarged partial end elevational view further illustrating components of the shaker sleeve member in phantom.

FIG. 10 is partial side elevational view with some parts omitted for clarity of the dispensing apparatus of FIGS. 1 and 2, illustrating the dispensing container for the dry pourable paint component being loaded into/unloaded from the dispensing apparatus.

FIG. 11 is a partial side elevational view with some parts omitted for clarity similar to FIG. 10, illustrating the dispensing container ready for dispensing of the liquid paint component.

FIG. 12 is a partial side elevational view with some parts omitted for clarity similar to FIG. 11, illustrating the dry pourable paint component being dispensed from the dispensing container.

FIG. 13a is an enlarged, partial side elevational view of a force applying mechanism for the cover element of the dispensing container with the cover element shown in the closed position corresponding to FIG. 4a.

FIG. 13b is an enlarged, partial side elevational view similar to FIG. 13a with the cover element shown in the opened position corresponding to FIG. 4b.

FIG. 14 is an enlarged, partial top elevational view of the force applying mechanism shown in FIG. 13a.

### DETAILED DESCRIPTION OF THE PREFERRED EMBODIMENTS

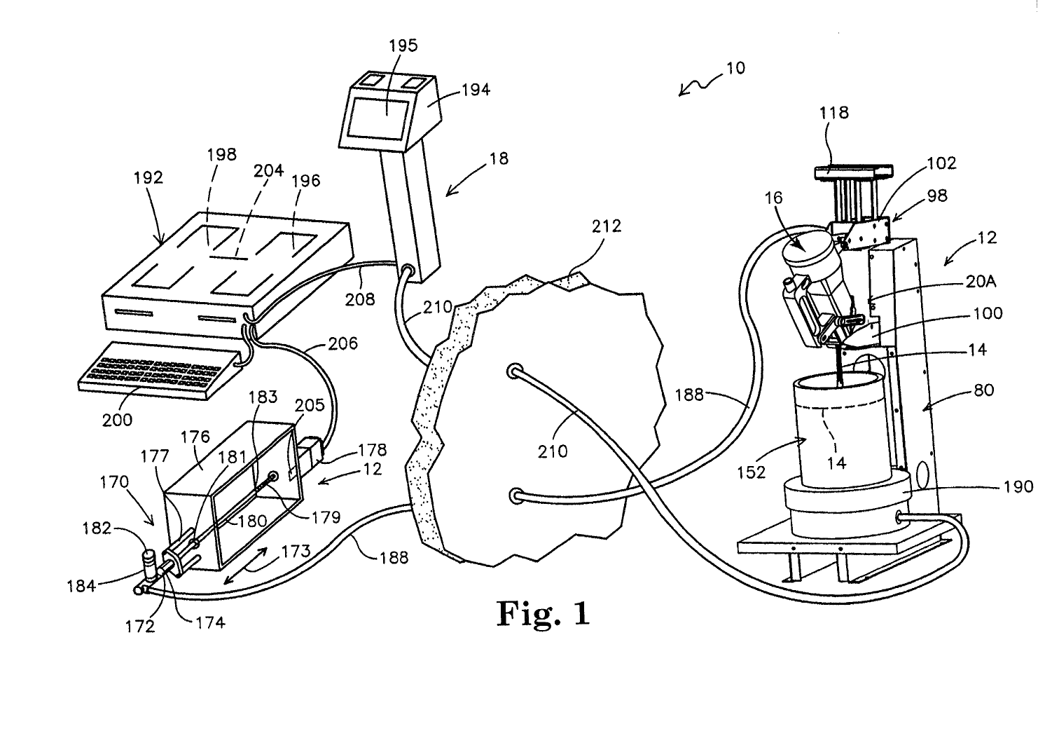

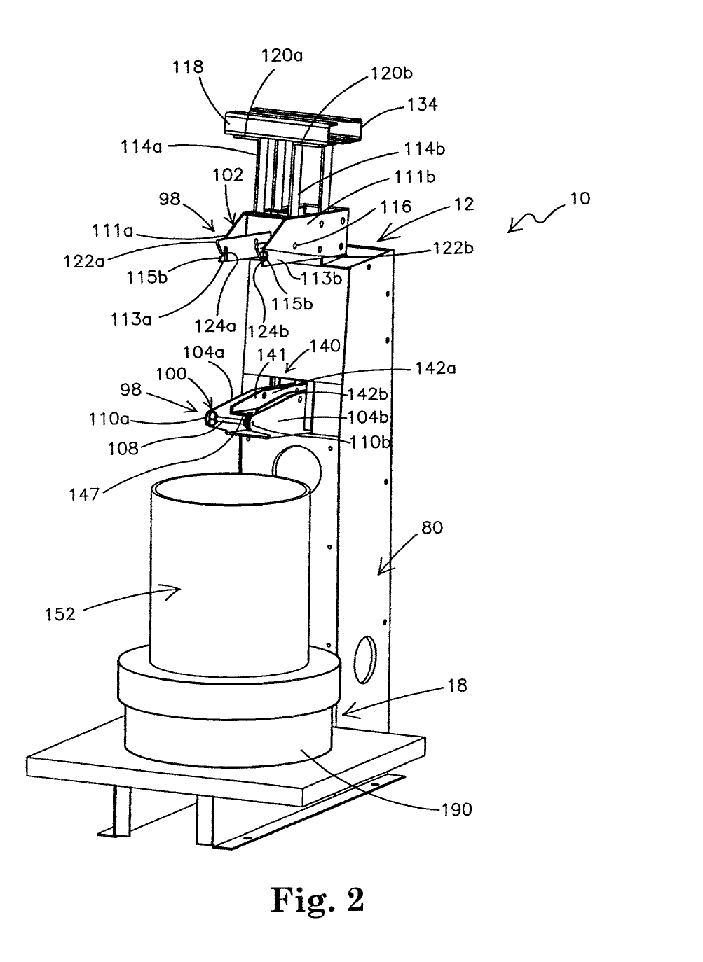

A semi-automated dispensing system 10 for dispensing dry and liquid paint components according to a paint formula to form a liquid paint mixture is illustrated generally in FIGS. 1 and 2. The dispensing system 10 generally comprises a dispensing apparatus 12 for dispensing liquid paint components from their original containers, and for dispensing a dry pourable paint component, such as a pearlescence powder 14, from a dry pourable component (i.e., pearlescence powder) dispensing container 16 in accordance with the present invention. A control apparatus 18 controls the dispensing apparatus 12.

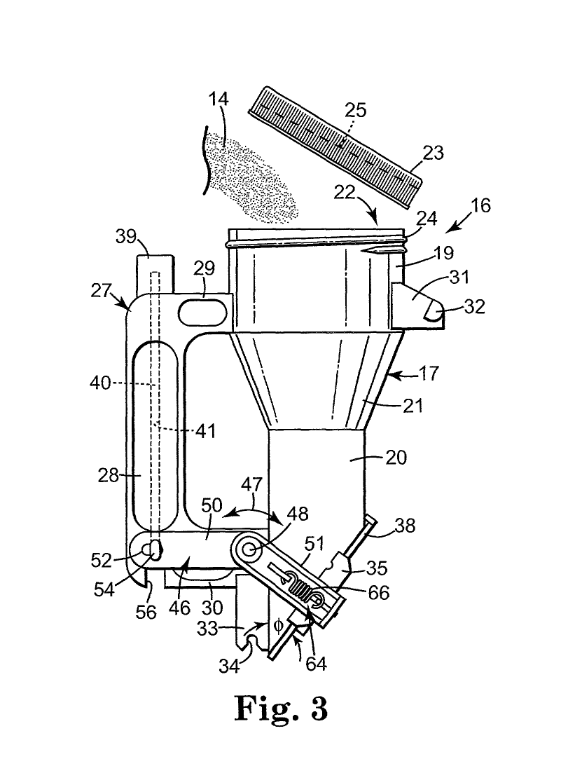

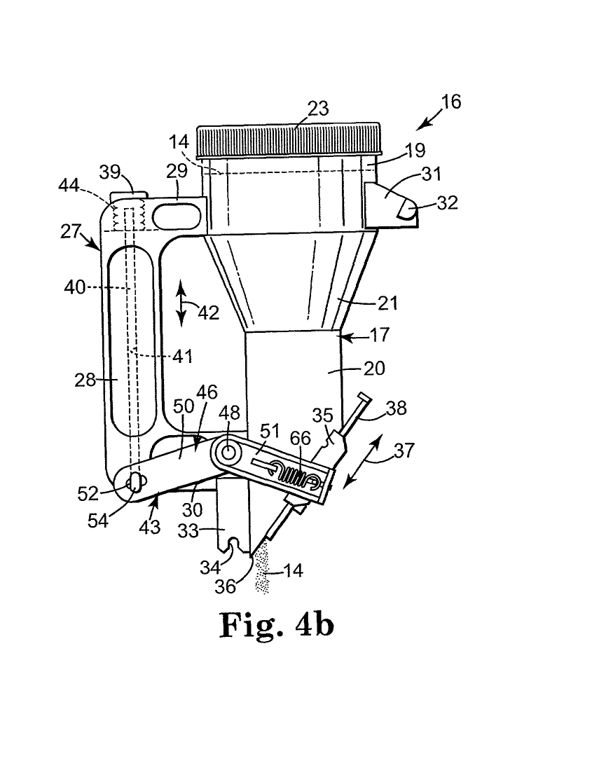

As seen in FIGS. 3-9, the dispensing container 16 includes a main body 17 defined by an upper portion 19 which is cylindrical in cross section, a lower portion 20 which is square in cross section, and an intermediate portion 21 which is funnel shaped to connect the upper portion 19 to the lower portion 20. As seen best in FIG. 3, a free end of the upper portion 19 of the main body 17 defines a fill opening 22 through which the main body 17 of the container 16 can be filled with the dry pourable paint component 14. A removable cap member 23 closes the fill opening after the main body 17 has been filled with the dry pourable component 14. In order to releasably secure the cap member 23 to the main body 17, the upper portion 19 includes screw threads 24 that cooperate with corresponding screw threads 25 of the cap member 23. As seen in FIG. 5, the cap member 23 is of sufficient diameter to allow the dispensing container 16 to be stored in a non-use state resting on the cap member 23 atop a support structure, such as a table 26.

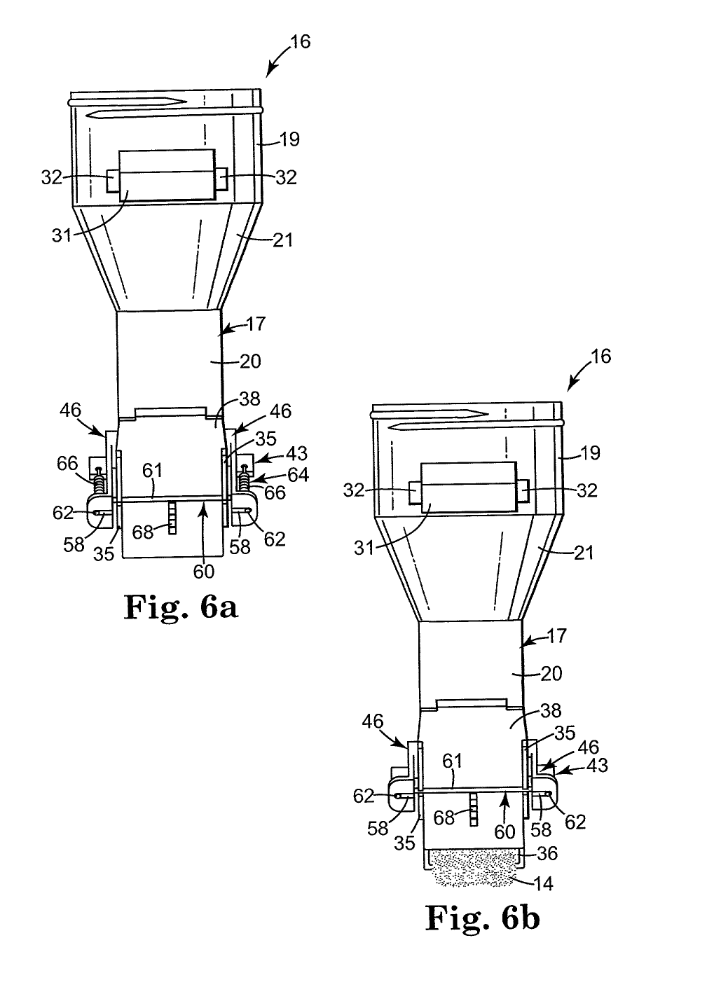

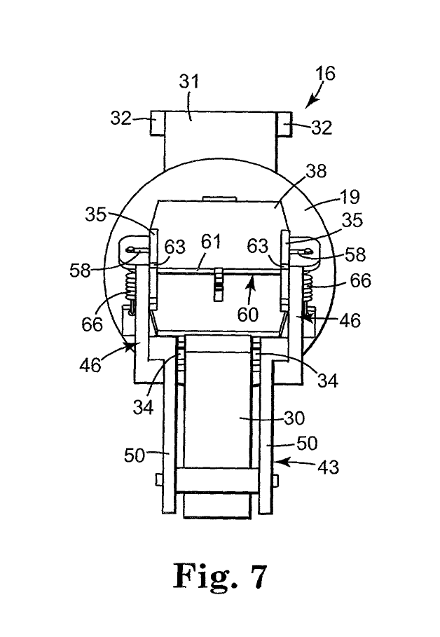

As seen in FIGS. 3-5, the dispensing container 16 also includes a U-shaped handle member 27 for easy handling of the dispensing container 16. The handle member 27 includes a main portion 28 which is grasped by a user, a first leg portion 29 coupled to the main body 17 of the dispensing container 16 at the upper portion 19, and a second leg portion 30 coupled to the main body 17 at the lower portion 20. Opposite the handle member 27 the upper portion 19 of the main body 17 includes latch bracket 31 having a pair of oppositely directed dispensing system latch lugs 32 (see FIGS. 6a, 6b and 7). The purpose of the pair of dispensing system latch lugs 32 will become clear below. In addition, as seen best in FIGS. 3-5 and 7, adjacent the second leg portion 30 of the handle 27, the lower portion 20 of the main body 17 includes a pair of spaced alignment brackets 33 that define alignment slots 34. The purpose of the alignment slots 34 will become clear below.

In one preferred embodiment the main body 17, the handle member 27, the latch bracket 31 and the alignment brackets 33 are all integrally molded as a single unit from a durable plastic material. Alternatively, these elements can be separately molded then secured together using a suitable adhesive.

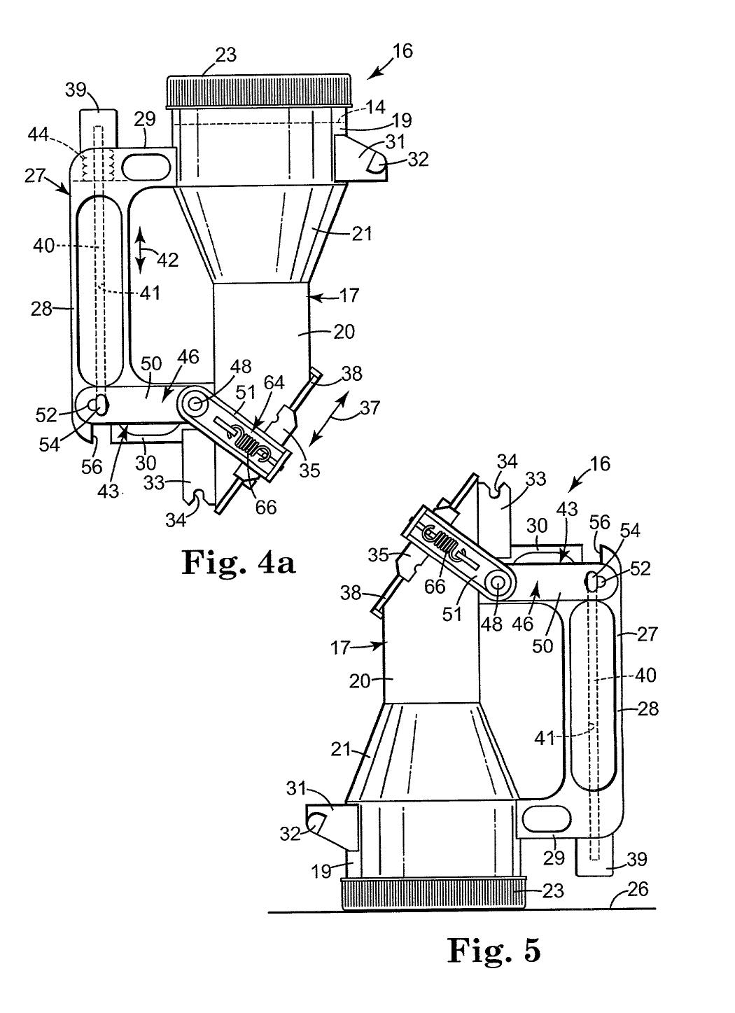

As seen in FIGS. 3-9, a free end of the lower portion 20 of the main body 17 defines a dispensing opening 36 through which the dry pourable paint component 14 can be dispensed from the main body 17 of the dispensing container 16. The dispensing opening 36 forms an acute angle Φ (see FIG. 3) with respect to a side wall of the lower portion 20 of the main body 17. The dispensing opening 36 is covered by a linearly movable, as represented by double headed directional arrow 37 (see FIGS. 4a and 4b), cover element 38. The cover element 38 is linearly movable between a closed state (shown in FIGS. 4a, 6a and 8a) and an opened state (shown in FIGS. 4b, 6b and 8b). To insure that the cover element 38 only moves linearly, the cover element 27 includes side walls 35 that freely engage the exterior of the lower portion 20 of the main body 17 adjacent the dispensing opening 36. In the closed state of the cover element 38, the dry pourable paint component 14 is prevented by the cover element 38 from being poured (i.e., dispensed) from the dispensing container 16 through the dispensing opening 36. Although engagement alone of the cover element 38 with the dispensing opening 36 prevents unwanted leakage of the dry pourable paint component 14 from the dispensing opening 36 in the closed state of the cover element 38, the cover element 38 and/or the dispensing opening 36 can be provided with seal structures to further insure that the dry pourable paint component 14 does not leak from the dispensing opening 36 in the closed state of the cover element 38. Suitable seal structures for the interface between the cover element 38 and the dispensing opening 36 are disclosed in previously referred to U.S. Pat. Nos. 6,230,938 and 6,290,110. In the opened state of the cover element 38, the dry pourable paint component 14 can be poured from the dispensing container 16 through the dispensing opening 36.

As seen when comparing FIGS. 4a and 4b, the cover element 38 is movable between its closed and opened states via a manually operable thumb actuator 39 that includes a rod element 40 that is linearly movable within a tube 41 defined within the main portion 28 of the handle 27. The thumb actuator 39 with rod element 40 is linearly movable relative to the handle 27 as shown by double headed directional arrow 42. As seen best in FIGS. 4a, 4b and 7, the rod element 40 of the thumb actuator 39 is coupled to the cover element 38 via a linking mechanism 43, such that manually depressing and releasing the thumb actuator 39 moves the cover element 38 between the closed and opened states. When the thumb actuator 39 is positioned as shown in FIG. 4a, the cover element 38 is in its closed state. The thumb actuator 39 is biased to this normal, closed state position in a by a coil spring element 44 (see FIGS. 4a and 4b). The coil spring element 44 acts between the handle member 27 and the thumb actuator 39. When the thumb actuator 39 is positioned as shown in FIG. 4b, the cover element 38 is in its opened state.

As seen best in FIGS. 3-7, the linking mechanism 43 includes a pair of angled link elements 46 pivotally mounted (see directional arrow 47 in FIG. 3) at their median by bearing member 48 to the second leg portion 30 of the handle member 27. Each angled link element 46 includes a first leg portion 50 and a second leg portion 51. The first leg portion 50 of each angled link element 46 defines a slot 52 for receiving a cross member 54 attached to the rod element 40 opposite the thumb actuator 39. The second leg portion 30 of the handle 27 includes a channel 56 to accommodate movement of the cross member 54 relative to the handle member 27 upon actuation of the thumb actuator 39. As seen when comparing FIGS. 4a and 4b, the slots 52 in the first leg portions 50 of the angled link elements 46 accommodate the transitional linear to pivotal movement between the rod element 40 of the thumb actuator 39 and the angled link elements 46.

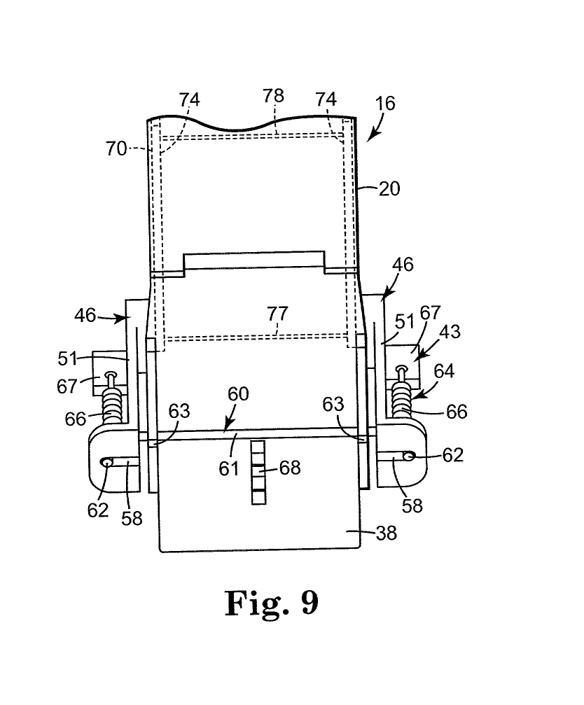

As seen best in FIG. 9, a U-shaped connecting rod 60 couples the second leg portions 51 of the angled link elements 46 to the cover element 38. The U-shaped connecting rod 60 is defined by a middle connecting portion 61 having first and second legs 62 that extend perpendicular to the connecting portion 61 at opposite ends thereof. The connecting portion 61 is freely received by channels 63 in the side walls 35 of the cover element 38. The first and second legs 62 of the connecting rod 60 are freely movably received in slots 58 defined in the second leg portions 51 of the angled link elements 46.

A biasing mechanism 64 provides a biasing force that causes the connecting portion 61 of the connecting rod 60 to bear against the cover element 38 to hold the cover element 38 against the dispensing opening 36 to prevent leakage of the dry pourable paint component 14 from the dispensing opening 36 in the closed state of the cover element 38. The biasing mechanism 64 includes a pair of tension springs 66. One tension spring 66 is coupled between a spring bracket 67 on the second leg portion 51 of one angled link element 46 and the connecting rod 60 at the intersection of the connecting portion 61 and the first leg 62. The other tension spring 66 is coupled between a spring bracket 67 on the second leg portion 51 of the other angled link element 46 and the connecting rod 60 at the intersection of the connecting portion 61 and the second leg 62. The slots 58 in the second leg portions 51 of the angled link elements 46 and the springs 66 accommodate the transitional pivotal to linear movement between the angled link elements 46 and the cover element 38. The cover element 38 is moved, from its closed state to its opened state, through the linear movement of the thumb actuator 39 and rod element 40, which causes the pivotal movement of the angled link elements 46, which in turn causes the linear movement of the cover element 38 via the connecting rod 60 and the biasing mechanism 64. The cover element 38 is allowed to return to its closed state from the opened state by simply releasing the thumb actuator 39. As seen in FIGS. 6a, 6b and 7, the cover element 38 also includes a slot 68 the purpose of which will be made clear below.

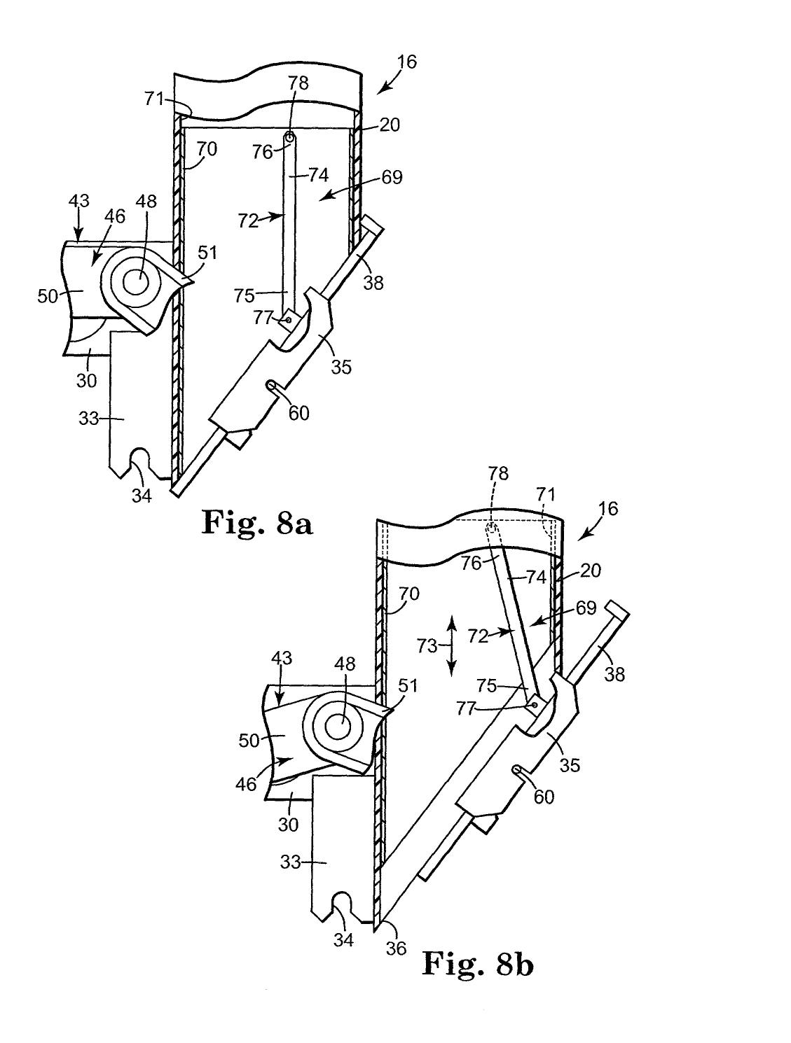

As seen in FIGS. 8a, 8b and 9, the dispensing container 16 further includes a shaker mechanism 69 to prevent “bridging” affect of the particles that make up the dry pourable component 14. These particles over time tend to form adhesive type interconnections with one another that can cause the dry component 14 to be dispensed in undesired clumps. To prevent this bridging effect, the shaker mechanism 69 includes a linearly movable sleeve member 70 that is shaped like the lower portion 20 of the main body 17 so that the sleeve member 70 is in a close fitting arrangement with an interior surface 71 of lower portion 20 of the main body 17 of the dispensing container 16. A coupling mechanism 72 couples the sleeve member 70 to the cover element 38, such that upon movement of the cover element 38 between the closed and opened states, the sleeve member 70 moves up and down linearly (see arrow 73) relative to the interior surface 71 of the lower portion 20 of the main body 17 of the container 16. Linear movement of the sleeve member 70 tends to break up adhesions (i.e., bridges) formed between particles defining the dry pourable component 14 thereby insuring that the dry pourable component 14 is dispensed from the dispensing opening 36 in a smooth consistent fashion (i.e., not in clumps).

The coupling mechanism 72 includes a pair of spaced connecting members 74. Each connecting member 74 has a first end 75 and an opposite second end 76. The first end 75 of each connecting member 74 is pivotally mounted to the cover element 38 by a pivot element 77, while the second end 76 of each connecting member 74 is pivotally mounted to the sleeve member 70 by a further pivot element 78. As seen when comparing FIGS. 8a and 8b, the pivot elements 77, 78 accommodate the transitional linear to linear movement between the cover element 38 and the sleeve member 70 upon actuation of the thumb actuator 39.

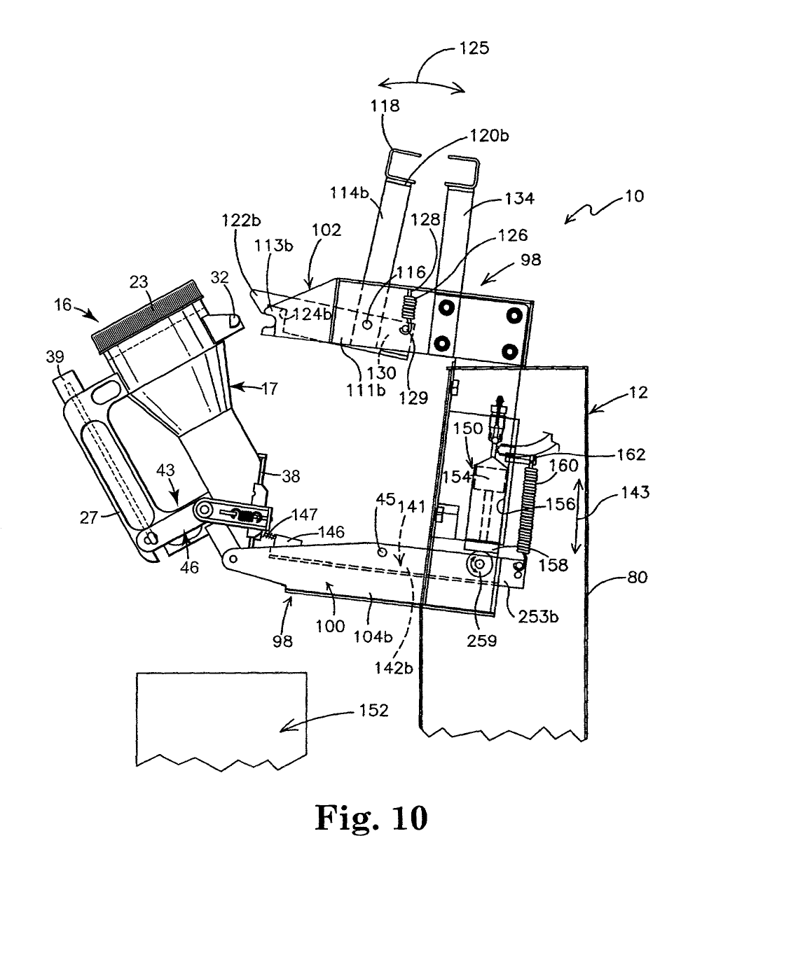

As seen best in FIGS. 1 and 2, the dispensing apparatus 12 of the dispensing system 10 includes a support frame 80. As seen best in FIGS. 2 and 10, the dispensing apparatus 12 further includes a receiving mechanism 98 for releasably engaging the dispensing container 16 of the dry pourable paint component 14. The receiving mechanism 98 is defined by first and second engaging mechanisms 100 and 102, respectively.

As seen best in FIG. 2, the first engaging mechanism 100 includes first and second spaced arms 104a and 104b rigidly mounted to the support frame so as to be fixed against movement relative thereto. A registration rod 108 rigidly connects together the first and second arms 104a and 104b at their free ends 110a and 110b. The registration rod 108 is adapted to releasably receive (i.e., engage) the alignment slots 34 of the container 16. As seen in FIG. 10, interengagement of the alignment slots 34 with the registration rod 108 mounts (i.e., secures) and aligns a first portion of the container 16 to the receiving mechanism 98 of the dispensing apparatus 12.

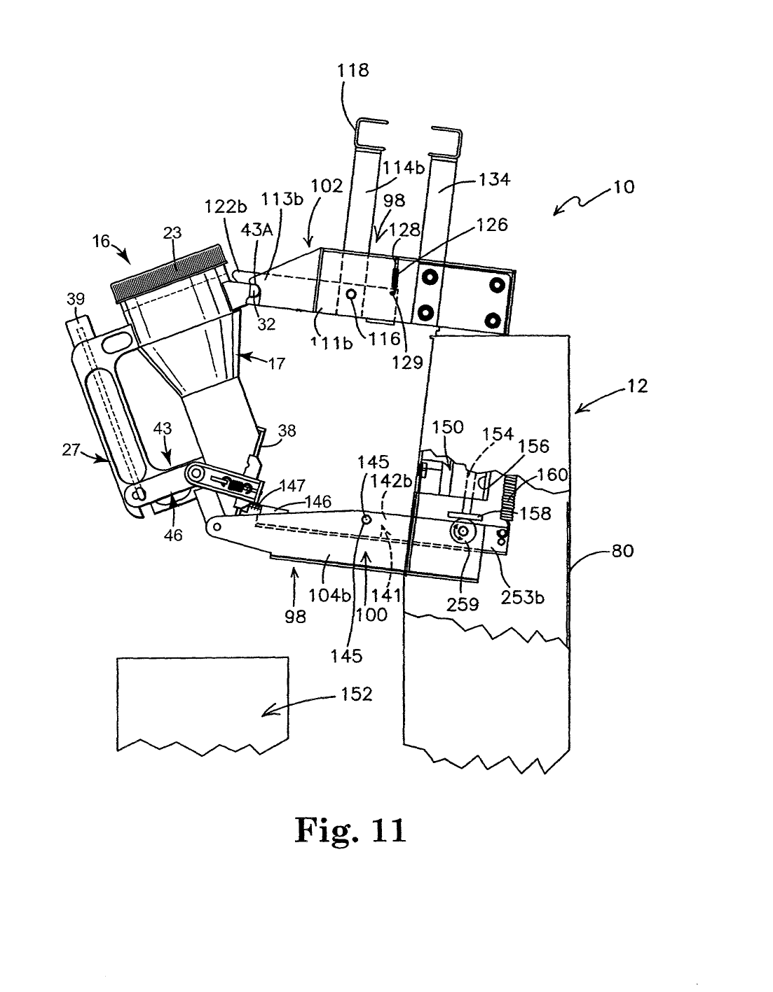

The second engaging mechanism 102 includes first and second spaced plates 111a and 111b fixed to an upper end of the support frame 80. Free ends 113a and 113b of the plates 111a, 111b include latch slots 115a and 115b, respectively. The second engaging mechanism 102 further includes first and second spaced L-shaped arms 114a and 114b pivotally mounted to the support frame 80 via a pivot pin 116. A handle member 118 rigidly connects together the first and second L-shaped arms 114a and 114b at their first ends 120a and 120b. Second ends 122a and 122b of the first and second L-shaped arms 114a and 114b include latching notches 124a and 124b. The latching notches 124a and 124b are adapted to releasably receive (i.e., engage) the latch lugs 32 on the upper portion 19 of the main body 17 of the container 16 to secure the latch lugs 32 in the latch slots 115a and 115b of the plates 111a, 111b. The L-shaped arms 114a and 114b of the second engaging mechanism 102 are pivotally movable as a unit, as represented by double headed arrow 125, between an unlatched state, wherein the container 16 of the dry paint component 14 can be engaged with and disengaged from the first and second engaging mechanisms 100 and 102 (shown in FIG. 10); and a latched state, wherein the dispensing container 16 is securely held between the first and second engaging mechanisms 100 and 102 (shown in FIG. 11). As such the L-shaped arms 114a and 114b (i.e., the second engaging mechanism 102) exhibits only a single-degree-of-freedom of movement (i.e., pivotal movement only) relative to the support frame 80 and the first engaging mechanism 100 (i.e., the first and second spaced arms 104a and 104b). A tension spring element 126 is coupled between a mounting peg 128 of the support frame 80 and a mounting peg 129 of an extension arm 130 on the L-shaped arm 114a. The tension spring element 126 biases the L-shaped arms 114a and 114b defining a portion of the second engaging mechanism 102 to the latched state against the stop 133. A handle/stop member 134 limits movement of the L-shaped arms 114a and 114b in a clockwise direction as viewed in FIG. 10.

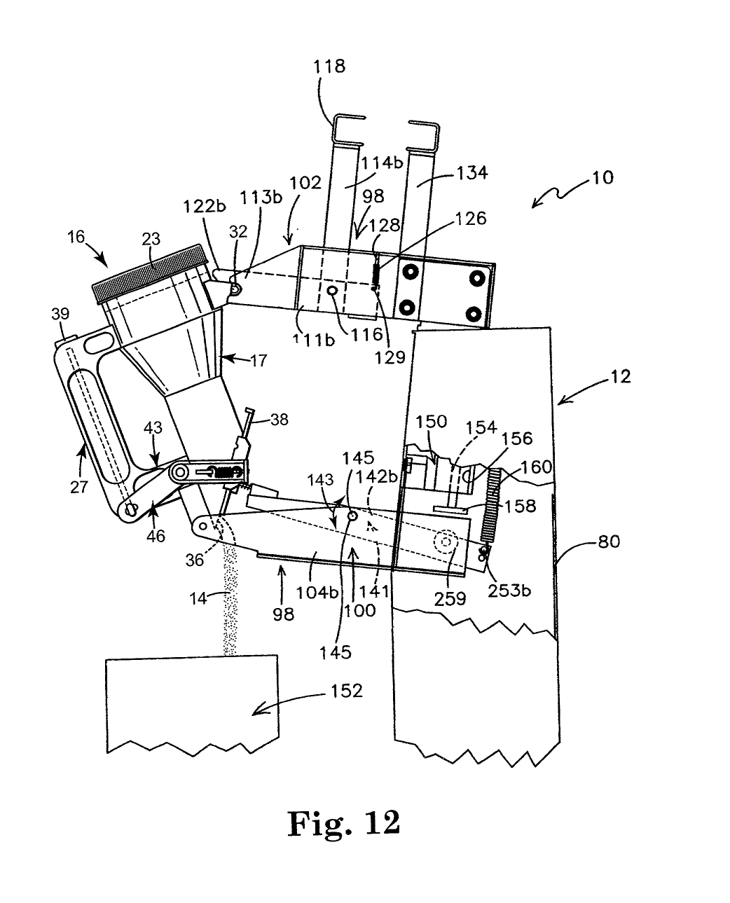

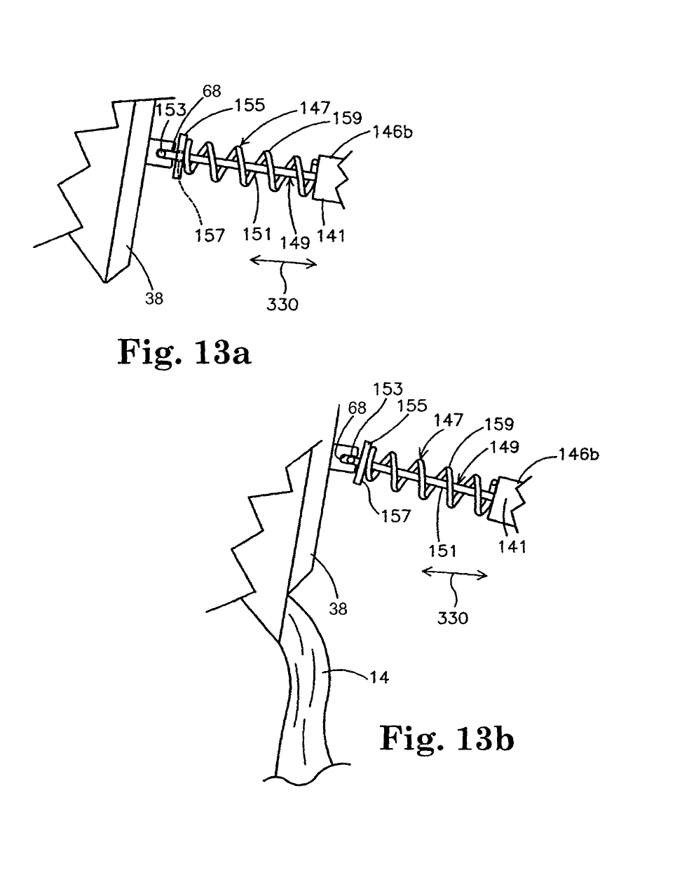

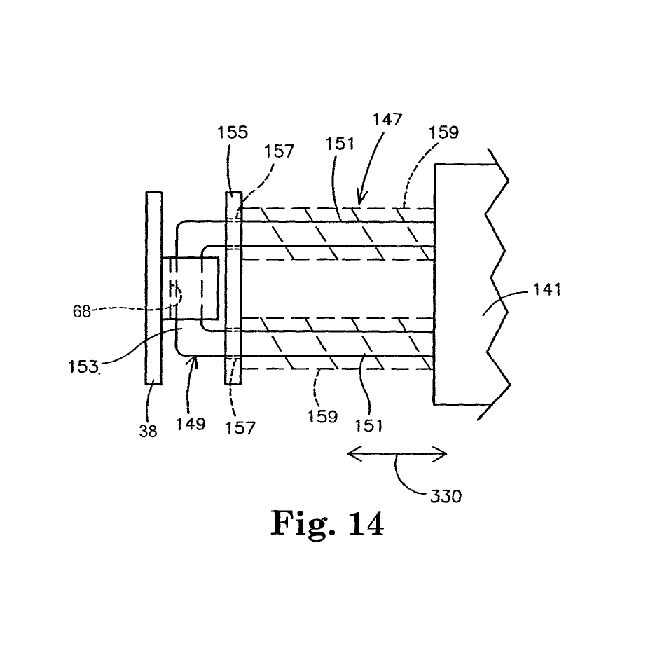

As seen best in FIGS. 2 and 12, the dispensing apparatus 12 of the dispensing system 10 further includes dispensing mechanism 140 mounted to the support frame 80 for moving the cover element 38 of the dispensing container 16 between its closed and open states. The dispensing mechanism 140 includes outwardly extending, first and second arms 142a and 142b that define an operating device 141 pivotally movable, as a unit, as represented by double headed directional arrow 143 (FIG. 12), relative to the support frame 80 about an axle 145. The free ends 146a and 146b, of the first and second arms 142a and 142b, include a force applying mechanism 147 (seen best in FIGS. 13a-14) adapted to releasably engage the slot 68 in the cover element 38 on the dispensing container 16 (see FIGS. 12-14). The force applying mechanism 147 includes U-shaped wire member 149 having legs 151 and a connecting portion 153. The legs 151 are rigidly mounted to the operating device 141. As seen best in FIGS. 13a, 13b and 14, the connecting portion 153 is releasably received within the slot 68 of the cover element 38. The force applying mechanism 147 further includes a force applying plate member 155 that is linearly movable relative to the U-shaped wire member 149 as represented by double headed arrow 330. The force applying plate member 155 includes apertures 157 that freely receive the legs 151 of the U-shaped wire member 149 to permit movement of the plate member 155 along the legs 151. A compression spring 159 surrounds each of the legs 151 and acts between the operating device 141 and the plate member 155 to provide a biasing force urges the plate member 155 against the cover element 38 to prevent inadvertent leakage of the dry paint component 14 from the dispensing opening 36 of the container 16 when the container 16 is mounted in the dispensing system 10 (see FIG. 11) and the cover element 38 is in a closed position.

As seen in FIG. 12, with the connecting portion 153 of the force applying mechanism 147 of the operating device 141 engaged with the slot 68 of the cover element 38, a transit mechanism 150 of the dispensing mechanism 140 can pivotally move the operating device 141 between a first position and a second position. In the first position of the operating device 141 (FIG. 11), the cover element 38 is in its closed state which prevents the dry paint component 14 from being dispensed from the container 16. In the second position of the operating device 141 (FIG. 12), the cover element 38 is in its opened state which allows the dry paint component 14 to be dispensed (i.e., poured) from the container 16 and into a paint receptacle 152 (FIG. 1).

As seen best in FIGS. 10-12, the transit mechanism 150 of the dispensing mechanism 140 includes a piston member 154 linearly movable, along directional arrow 143 (FIG. 10), relative to a cylinder member 156. Opposite ends 253a and 253b of the first and second arms 142a and 142b (defining the operating device 141) are coupled to the piston member 154. A pad member 158 of the piston member rides on a roller member 259 rotatably mounted to the arms 142a, 142b. Therefore movement of the piston member 154 within the cylinder member 156 causes the operating device 141 to move between its first and second positions. Tension spring elements 160 are coupled between the opposite ends 253a, 253b of the arms 142a, 142b and a mounting member 162 on the support frame 80. The tension springs 160 bias the operating device 141 to its first position (also known as the primary position of the piston member 154).

As seen in FIG. 1, a drive mechanism 170 of the transit mechanism 150 moves the piston member 154 relative to the cylinder member 156. The drive mechanism 170 includes a piston member 172 linearly movable, along double headed directional arrow 173, relative to a cylinder member 174 mounted to a frame 176 via bracket structure 177. A drive motor, such as a stepper motor 178, is also mounted to the frame 176. The drive motor 178 includes a drive screw 179 that is telescopically received within a drive tube 180 that is secured at one end to the piston member 172. The drive tube 180 is slidably received within a bearing 181 of the frame 176 to allow movement of the drive tube 180, and the piston member 172 therewith, relative to the frame 176, drive motor 178 and cylinder member 174. An opposite end of the drive tube 180 includes a drive nut 183 that threadably receives the drive screw 179 of the stepper motor 178. Operation of the stepper motor 178 turns the drive screw 179 within the drive nut 183. This in turn moves the drive tube 180 and therewith the piston member 172 within the cylinder member 174 along directional arrow 173. A fluid reservoir 182 containing a hydraulic fluid 184 is in fluid communication with the cylinder member 174. A fluid line 188 couples the fluid reservoir 182 to the cylinder member 156. In operation, movement of the piston member 172, via the stepper motor 178, forces hydraulic fluid 184 to move to and from the cylinder member 174 and the fluid reservoir 182 through the line 188 then into and out of the cylinder member 156 to move the piston member 154. Movement of the piston member 154, via the above described hydraulic fluid pressure, in turn moves the operating device 141 which in turn moves the cover element 38 of the dispensing container 16 between its opened and closed states.

As seen in FIG. 1, the control apparatus 18 of the dispensing system 10 includes a weigh cell 190 for supporting the paint receptacle 152 and a control module 192. The weigh cell 190 determines the weight of the dry paint component dispensed (i.e., poured) from the container 16 into the paint receptacle 152. The control module 192 includes a display monitor device 194 having a display 195, a microprocessor device 196, a data storage device 198 and a user interface device, such as a keyboard 200. The keyboard 200 is coupled to the microprocessor device 196 via a communication line 202. The microprocessor device 196 and the data storage device 198 are linked through a communication line 204. The microprocessor device 196 is linked to the stepper motor 178 and to a sensor 205 for monitoring the position of the drive screw 179 through the communication line 206. The microprocessor device 196 is linked to the display monitor device 194 through communication line 208 and is further linked to the weigh cell 190 via communication line 210. Since the control module 192 (i.e., microprocessor device 196) is linked to the stepper motor 178 and the sensor 205, the control module 192 can control operation of the stepper motor 178, and thereby movement of the piston members 172 and 154, and hence movement of the cover element 38 to dispense the dry paint component 14 from the container 16. In addition, since the control module 192 is further linked to the weigh cell 190, the control module 192 can control the amount (i.e., the weight) of the dry paint component 14 dispensed from the container 16 to the paint receptacle 152 (atop the weigh cell 190) based upon data (i.e., information) obtained from the weigh cell 190. Moreover, since the control module 192 (i.e., the data storage device 198) stores the paint formulas, the control module 192 can determine which paint components and the weights of these components needed to duplicate a particular paint formula and can control the dispensing mechanism 140 in accordance therewith.

As seen in FIG. 1, the control module 192 and the drive mechanism 170 are positioned in another room such that the communication line 210 and the fluid line 188 pass through a wall 212 so as to provide explosion protection for the dispensing system 10. Alternatively, one or more of the display monitor device 194, the microprocessor device 196, and the keyboard 200 could be located next to the dispensing system 10 provided that these components are explosion protected.

In operation, to mix a particular paint formula, the operator of the semi-automated dispensing system 10 first accesses the control module 192 through the keyboard 200 to call up the desired paint formula using the microprocessor device 196 the data storage device 198. The paint formula (i.e., the liquid paint components and the dry paint component 14) is then displayed on the display 195 of the display monitor device 194. The operator then loads the first container 16 of the needed dry pourable paint component into the dispensing apparatus 12.

As seen in FIG. 10, to mount (i.e., load) the container 16 of the dry pourable paint component 14 to the receiving mechanism 98 of the dispensing apparatus 12, the operator of the dispensing system 10 first needs to pivot the second engaging mechanism 102 (defined by the L-shaped anus 114a, 114b) clockwise (as viewed in FIG. 10) from its normal latched state to its unlatched state, against the handle/stop member 134 mounted to the support frame 80. The operator, while gripping both the handle member 118 and the handle/stop member 134 to hold the second engaging mechanism 102 in its unlatched state (against the bias of the spring element 126), then engages the alignment slots 34 of the container 16 with the registration rod 108 of the first engaging mechanism 100 (FIG. 10). Next, while still holding the second engaging mechanism 102 in its unlatched state, the operator pivots the container 16 clockwise (as viewed in FIG. 10) until the connecting portion 153 of the force applying mechanism 147 of the operating device 141 is fully seated in the slot 68 of the cover element 38, and the latch lugs 32 are filly seated in the latch slots 115a, 115b of the plates 111a, 111b. With the alignment slots 34 now fully seated on the registration rod 108, the connecting portion 153 of the operating device 141 fully seated in the slot 68 of the cover element 38, and the latch lugs 32 filly seated in the latch slots 115a, 115b, the operator pivots the second engaging mechanism 102 counter-clockwise to its latched state, so that the latching notches 124a and 124b engage the latch lugs 32 of the container 16 securing the container 16 to the receiving mechanism 98 the dispensing apparatus 12. To remove the container 16 from the dispensing apparatus 12, this above described process is simply reversed.

The operator then starts the dispensing process using the keyboard 200 of the control module 192. Since the control module 192 (i.e., microprocessor device 196) is linked to the stepper motor 178 and the sensor 205, the control module 192 controls operation of the stepper motor 178, and thereby movement of the piston members 154 and 172, and hence movement of the cover element 38 to dispense (i.e., pour) the dry paint component 14 from the container 16 into the paint receptacle 152. The arrangement of the second engaging mechanism 102 and the latch lugs 32 prevents movement of the cover element 38 from inadvertently disengaging the alignment slots 34 from the first registration rod 108. The weight of the dry paint component 14 dispensed into the paint receptacle 152 is monitored by the control module 192 through the weigh cell 190, thereby ensuring an accurate dry paint component pour. Once the dry paint component 14 is poured, the container 16 is removed and is replaced with the next paint component container and so on, until all dry and liquid paint components of the paint formula have been added to the paint receptacle 152, thereby completing the paint formula mixing process.

This dispensing container 16 for a dry pourable paint component 14 is compatible with the semi-automated dispensing system 10, for dispensing both liquid and dry paint components that virtually eliminates system operator errors, in particular over pouring errors, that can be costly to a body shop or jobber. The dispensing container 16 together with the semi-automated dispensing system 10 is easy to use, and does not require a highly skilled operator, since operator interface with the container 16 and the dispensing system 10 is substantially limited to identifying the desired paint formula, and loading and unloading the containers 16 for the dry paint component 14 to and from the dispensing apparatus 12. The operator need no longer manually pour the dry paint component 14. The cover element/dispensing system interface automatically dispenses (i.e., pours) the dry paint component 14 from the container 16 thereby ensuring a highly accurate, precision dry paint component pour. Moreover, the shaker mechanism 69 prevents bridging of the particles that define the dry pourable paint component 14. In addition, the dispensing container 16, of the present invention, together with the paint dispensing system 10, makes efficient use of the operator's time, since the operator is free to perform other duties instead of performing the task of pouring manually. This efficiency gain allows the operator to mix a greater number of paint formulas during a work day. Lastly, the paint component container 16, of the present invention, and the semi-automated dispensing system 10 comply with all regulations and laws, such as being explosion protected, governing the handling and mixing of paint components for the duplication of automotive paint formulas.

Although the present invention has been described with reference to preferred embodiments, workers skilled in the art will recognize that changes may be made in form and detail without departing from the spirit and scope of the invention. For example, although the dispensing container 16 and the semi-automated dispensing system 10 have been described as useable to dispense a dry pourable automotive paint component 14 the container 16 and the dispensing system 10 can be used to dispense other pourable components, such as powdered chemicals. In particular the dispensing container 16 and the dispensing system 10 could be used in laboratory or pharmaceutical organizations to accurately dispense powdered chemicals according to a desired formula.

1. A container for dispensing a dry pourable component, the container being usable with a system for dispensing the dry pourable component from the container into a receptacle according to a formula to form a mixture of liquid and dry pourable components, the container comprising:
a main body for containing the dry pourable component, the main body defining a dispensing opening through which the dry pourable component can be dispensed from the main body of the container; and
a cover element for the dispensing opening, the cover element being movably mounted to the main body such that the cover element is movable between a closed state, wherein the cover element covers the dispensing opening and the dry pourable component is prevented from being dispensed from the main body of the container, and an opened state, wherein the dispensing opening is uncovered and the dry pourable component can be dispensed from main body of the container through the dispensing opening and into the receptacle.

2. The container of claim 1 wherein the main body further defines a fill opening through which the main body of the container can be filled with the dry pourable component.

3. The container of claim 2, and further including:
a removable cap member for closing the fill opening after the main body has been filled with the dry pourable component.

4. The container of claim 3 wherein the removable cap member includes screw threads, and wherein the main body adjacent the fill opening includes corresponding screw threads that cooperate with the screw threads of the removable cap member to removably secure the cap member to the main body of the container.

5. The container of claim 3 wherein the container has a non-use state wherein the container is stored resting on the cap member.

6. The container of claim 2 wherein the dispensing opening is at a first end of the main body of the container, and wherein the fill opening is at a second end of the main body which is opposite the first end.

7. The container of claim 2 wherein the main body of the container is defined by an upper portion which is cylindrical in cross section, a lower portion which is square in cross section, and an intermediate portion which is funnel shaped to connect the upper portion to the lower portion.

8. The container of claim 7 wherein the fill opening is located at a free end of the upper portion of the main body, and wherein the dispensing opening is located at a free end of the lower portion of the main body.

9. The container of claim 1 wherein the dispensing opening is at an acute angle relative to a side wall of the main body of the container.

10. The container of claim 1 wherein the cover element is linearly movable relative to the dispensing opening of the main body.

11. The container of claim 1, and further including:
a manually operable actuator movably mounted to the main body of the container; and
a linking mechanism mounted to the main body for coupling the manually operable actuator to the cover element, such that manually moving the actuator moves the cover element between its closed and opened states.

12. The container of claim 11 wherein the manually operable actuator is mounted to the main body portion so as to move linearly relative thereto.

13. The container of claim 12 wherein the linking mechanism includes:
at least one link element movably mounted to the main body of the container, the at least one link element having a first end coupled to the manually operable actuator and a second end coupled to the cover element.

14. The container of claim 13 wherein the at least one link element is pivotally mounted to the main body of the container.

15. The container of claim 12 wherein the linking mechanism includes:
a pair of link elements pivotally mounted to the main body of the container, each of the link elements having a first end coupled to the manually operable actuator and a second end.

16. The container of claim 15, and further including:
a connecting mechanism for coupling the second ends of the link elements to the cover element.

17. The container of claim 16 wherein the connecting mechanism includes:
a connecting element connected between the second ends of the link elements, the connecting element having a connecting portion that is coupled to the cover element.

18. The container of claim 17 wherein the cover element includes at least one slot for receiving the connecting portion of the connecting element for coupling the connecting element to the cover element.

19. The container of claim 17 wherein the connecting mechanism further includes:
a biasing mechanism for providing a biasing force that holds the cover element against the dispensing opening to prevent leakage of the dry pourable component from the dispensing opening in the closed state of the cover element.

20. The container of claim 19 wherein the biasing mechanism includes:
a tension spring connected between the connecting element and each link element.

21. The container of claim 1 wherein the cover element includes a pair of spaced side walls that engage the main body of the container to insure that the cover element moves linearly between the closed and open states.

22. The container of claim 1, and further including:
a shaker mechanism movable relative to the main body of the container to prevent bridging of particles defining the dry pourable component so that the dry pourable component is dispensed from the dispensing opening in a smooth fashion in the open state of the cover element.

23. The container of claim 22 wherein the shaker mechanism includes:
a sleeve member that is in a close fitting arrangement with a portion of an interior surface of the main body of the container.

24. The container of claim 23 wherein the shaker mechanism further includes:
a coupling mechanism for coupling the sleeve member to the cover element, such that upon movement of the cover element between the closed and opened states, the sleeve element moves linearly relative to the portion of the interior surface of the main body of the container.

25. The container of claim 24 wherein the coupling mechanism includes at least one connecting member having a first end pivotally mounted to the cover element and a second end pivotally mounted to the sleeve member.

26. The container of claim 25 wherein the at least one connecting member is a pair of spaced connecting members.

27. The container of claim 1, and further including:
operating means on the cover element releasably engageable by an operating device of the pourable component dispensing system that moves the cover element between its closed and opened states according to the formula to form the mixture of liquid and dry pourable components.

28. The container of claim 27, and further including:
alignment means on the main body releasably engageable by an engaging mechanism of the pourable component dispensing system for aligning the container on the dispensing system so that the operating device is in engagement with the operating means on the cover element.

29. The container of claim 28 wherein the alignment means is positioned on the main body of the container adjacent to the dispensing opening.

30. The container of claim 29 wherein the alignment means is defined by an alignment slot formed in the main body and releasably engageable with the engaging mechanism of the dispensing system.

31. The container of claim 27, and further including:
latch means on the main body releasably engageable by an latching mechanism of the pourable component dispensing system for securing the container on the dispensing system so that the operating device is in engagement with the operating means of the cover element.

32. The container of claim 31 wherein the latch means includes a pair of spaced latch lugs releasably engageable with the latching mechanism of the dispensing system.

33. The container of claim 32 wherein the main body further defines a fill opening through which the main body of the container can be filled with the dry pourable component.

34. The container of claim 33 wherein the pair of spaced latch lugs are positioned on the main body of the container adjacent to the fill opening.

35. The container of claim 1 wherein the main body includes a handle member.

36. The container of claim 27, and further including:
alignment means on a first portion of the main body releasably engageable by an engaging mechanism of the pourable component dispensing system for aligning the container on the dispensing system so that the operating device is in engagement with the operating means on the cover element; and
latch means on a second portion of the main body spaced from the first portion, the latch means being releasably engageable by a latching mechanism of the pourable component dispensing system for securing the original container on the dispensing system so that the operating device can move the cover element between its closed and opened states.

37. The container of claim 36 wherein the alignment means is defined by an alignment slot formed in the main body and releasably engageable with the engaging mechanism of the dispensing system.

38. The container of claim 37 wherein the latch means includes a pair of spaced latch lugs releasably engageable with the latching mechanism of the dispensing system.

39. The container of claim 27 wherein the operating means is slot formed in the cover element, the slot being releasably engageable with the operating device of the dispensing system.

40. The container of claim 1 wherein the dry pourable component is a pearlescence powder paint component, the receptacle is a paint receptacle, the formula is a paint formula, and the mixture of liquid and dry pourable components is a liquid paint mixture.

41. A container for preventing bridging of particles defining a dry pourable component, the container comprising:
a main body for containing the dry pourable component, the main body defining a dispensing opening through which the dry pourable component can be dispensed from the main body of the container; and
a shaker mechanism movable relative to the main body of the container to prevent bridging of the particles defining the dry pourable component so that the dry pourable component is dispensed from the dispensing opening in a smooth fashion.

42. The container of claim 41 wherein the shaker mechanism includes:
a sleeve member that is in a close fitting arrangement with a portion of an interior surface of the main body of the container.

43. The container of claim 42, and further including:
a manually operable actuator movably mounted to the main body of the container; and
a linking mechanism mounted to the main body for coupling the manually operable actuator to the sleeve member, such that manually moving the actuator moves the sleeve member between first and second positions relative to the interior surface of the main body.

44. The container of claim 43 wherein the manually operable actuator is mounted to the main body portion so as to move linearly relative thereto.

45. The container of claim 44 wherein the linking mechanism includes:
at least one link element movably mounted to the main body of the container, the at least one link element having a first end coupled to the manually operable actuator and a second end coupled to the sleeve member.

46. The container of claim 45 wherein the at least one link element is pivotally mounted to the main body of the container.

47. The container of claim 44 wherein the linking mechanism includes:
a pair of link elements pivotally mounted to the main body of the container, each of the link elements having a first end coupled to the manually operable actuator and a second end.

48. The container of claim 47, and further including:
a connecting mechanism for coupling the second ends of the link elements to the sleeve member.

49. The container of claim 48 wherein the connecting mechanism includes:
a cover element for the dispensing opening, the cover element being movably mounted to the main body such that the cover element is movable between a closed state, wherein the cover element covers the dispensing opening and the dry pourable component is prevented from being dispensed from the main body of the container, and an opened state, wherein the dispensing opening is uncovered and the dry pourable component can be dispensed from main body of the container through the dispensing opening.

50. The container of claim 49 wherein the connecting mechanism further includes:
a connecting element connected between the second ends of the link elements, the connecting element having a connecting portion that is coupled to the cover element.

51. The container of claim 50 wherein the cover element includes at least one slot for receiving the connecting portion of the connecting element for coupling the connecting element to the cover element.

52. The container of claim 49, and further including:
a coupling mechanism for coupling the sleeve member to the cover element, such that upon movement of the cover element between the closed and opened states, the sleeve element moves linearly relative to the portion of the interior surface of the main body of the container.

53. The container of claim 52 wherein the coupling mechanism includes at least one connecting member having a first end pivotally mounted to the cover element and a second end pivotally mounted to the sleeve member.

54. The container of claim 53 wherein the at least one connecting member is a pair of spaced connecting members.
